(19) United States
(12) Patent Application Publication
(10) Pub. No.: US 2013/0031327 A1
(43) Pub. Date: Jan. 31, 2013

(54) SYSTEM AND METHOD FOR ALLOCATING CACHE MEMORY

(71) Applicants: Yung CHANG, Kaohsiung City (TW); Po-Tsang Huang, Hsinchu City (TW); Wei Hwang, Hsinchu City (TW)

(72) Inventors: Yung CHANG, Kaohsiung City (TW); Po-Tsang Huang, Hsinchu City (TW); Wei Hwang, Hsinchu City (TW)

(21) Appl. No.: 13/192,856

(22) Filed: Jul. 28, 2011

(51) Int. Cl. G06F 12/02

(52) U.S. Cl. 711/170; 711/E12.002

(57) ABSTRACT

Different processor elements in multi-task/multi-core system on chip may have different memory requirements at runtime. The method for adaptively allocating cache memory re-allocates the cache resource by updating the bank assignment table. According to the associativity-based partitioning scheme, centralized memory is separated into several groups of SRAM banks which are numbered differently. These groups are assigned to different processor elements to be L2 caches. The bank assignment information is recoded in bank assignment table, and is updated by system profiling engine. By changing the information in bank assignment table, the cache resource re-allocation for processor elements is achieved.

### BACKGROUND OF THE INVENTION

1. Field of the Invention

The present invention relates to a system and method for allocating cache memory and, more particularly, to a system and method capable of allocating cache memory to each processor element in the system adaptively according to a bank assignment table that is updated by system profiling engine.

2. Description of Related Art

With the progressing of system on chip (SoC) and multimedia technology, the amount of data and computation required for processing increases rapidly. Multi-task processing technique becomes more and more important for integrating various processor elements into a single chip. Also, multi-system integration has become an inevitable tendency. Generally speaking, most systems require memories for storage. Under multi-task environment, memory is the kernel of storage system, and it is also the most serious bottleneck due to the performance of processor elements being much faster than the memory. Accordingly, the organization of memory for a multi-task/multi-core system will affect the system performance dramatically.

The number of processor elements in SoC system increases rapidly for processing hundreds of thousand procedures in the system, therefore, the data communication and memory access traffic problem are more and more serious for constructing multi-task/multi-core systems. Additionally, in a multi-task system, different processor elements may have quite different memory behavior. For instance, large memory requirement is required for video processor element but wireless processor element may not be. Therefore, poor memory utilization occurs if traditional memory allocation is still applied in such a multi-task/multi-core platform, which implies that cache memory allocation method in single fixed type is unable to satisfy the heterogeneous memory requirement for each processor element in the platform anymore if a common multi-task/multi-core system platform is to be constructed desirably.

As for traditional memory allocation, each processor element owns constant memory resource. Such memory allocation is inflexible, that is, each processor element in multi-task/multi-core platform may have different memory requirements during the runtime, while the loading of a particular processor element increases across two adjacent time intervals, for example the procedure that assigned for the processor element in the latter time interval is greater that that in the previous time interval, the efficiency of the processor element decreases due to the lack of memory resource. Further, while the loading of processor element decreases across two adjacent time intervals, extra power consumption occurs due to the memory idle since the memory has no information to store but keeps consuming power.

Therefore, how to manage and utilize the memory is the most important issue for constructing a multi-task/multi-core platform. Accordingly, it is desired to provide a system and method for allocating cache memory capable of allocating cache memory dynamically and adaptively to each processor element for increasing the efficiency of the entire system and diminishing the power consumption.

### SUMMARY OF THE INVENTION

An object of the present invention is to provide a method for allocating cache memory, which is able to allocate memory resource dynamically and adaptively to each processor element for increasing the efficiency of the system and to decrease the power consumption due to memory idle.

Another object of the present invention is to provide a system on chip capable of allocating memory resource dynamically and adaptively to each processor element in the system on chip for processing different task assigned to different processor element.

In one aspect of the invention, there is provided a method for allocating cache memory, applied in a system on chip and accompanied with a bank assignment table. The system on chip includes a plurality of processor elements and a cache memory element. The cache memory element has a plurality of sub-memory elements, and one of the plurality of processor elements executes the method. The method comprises the steps of reading the bank assignment table; and allocating the plurality of sub-memory elements to the plurality of processor elements, in accordance with the bank assignment table, for executing the operation processes assigned to the plurality of processor elements.

In another aspect of the invention, there is provided a system on chip for allocating cache memory, comprising: a plurality of processor elements; and a cache memory element including a plurality of sub-memory elements, and coupled with the plurality of processor elements, wherein a bank assignment table is built in one of the plurality of processor elements, and the processor element with the built-in bank assignment table allocates the plurality of sub-memory elements to the plurality of processor elements, in accordance with the bank assignment table, for executing an operation processes assigned to the plurality of processor elements.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view illustrating the system on chip (SoC) in accordance with an embodiment of the present invention;

FIG. 2 is a schematic view illustrating the cache memory element of the present invention;

FIG. 3 is a schematic view illustrating the bank table checking method when a request is served; and

FIG. 4 is a schematic view illustrating a general memory allocation.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

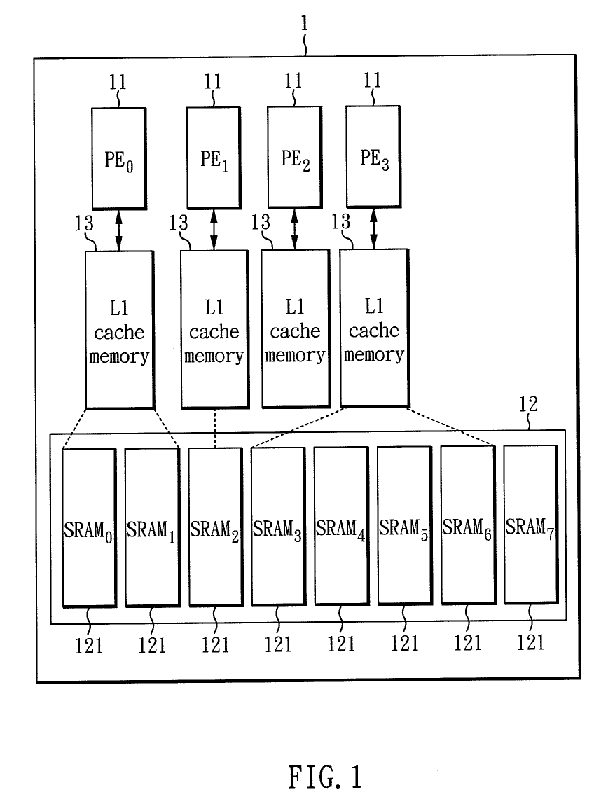

FIG. 1 is a schematic view illustrating the system on chip (SoC) for allocating cache memory in accordance with an embodiment of the present invention. As shown in FIG. 1, the system on chip 1 includes: a plurality of processor elements 11, and a cache memory element 12. Each processor element 11 further includes an L1 cache memory 13, and the L1 cache memory 13 is built in each processor element 11, wherein the L1 cache memory is the well-known technology for those skilled in the art and thus a detailed description is deemed unnecessary.

The cache memory element 12 includes a plurality of sub-memory elements 121; to be more specifically, the cache memory element 12 is divided into a plurality of sub-memory elements 121, each having a bank table. Further, the cache memory element 12 of the present invention is regarded as the well-known L2 cache. Moreover, a bank assignment table (not shown in this figure) is built in one of the plurality of processor elements 11, and the processor element 11 with the built-in bank assignment table is in charge of allocating the plurality of sub-memory elements 121 to the plurality of processor elements 11, in accordance with the bank assignment table, for executing the operation processes assigned to the plurality of processor elements 11. The processor element 11 with the built-in bank assignment table is also able to profile the memory requirements of the entire system.

In this embodiment, four processor elements 11 are utilized and the cache memory element 12 is divided into eight sub-memory elements 121 in the system on chip 1, wherein the sub-memory elements 121 are static random access memory elements. Moreover, as shown in FIG. 1, the eight sub-memory elements 121 are labeled as SRAM₀ to SRAM₇ and the four processor elements 11 are labeled as PE₀ to PE₃. Each processor element 11 includes an L1 cache memory 13, and the L1 cache memory 13 is built in each processor element 12. Further, in this embodiment, each processor element 11 has different memory requirements and hence unequal memory resources are allocated. As shown in FIG. 1, two sub-memory elements are allocated to PE₀, one sub-memory element is allocated to PE₁, four sub-memory elements are allocated to PE₃, and PE₂ is not allocated for any memory resource. Further, the power supplied to SRAM₇ is turned off since SRAM₇ is not allocated to any of the processor elements 11 for any data reading and writing and thus the electric power consumption is saved.

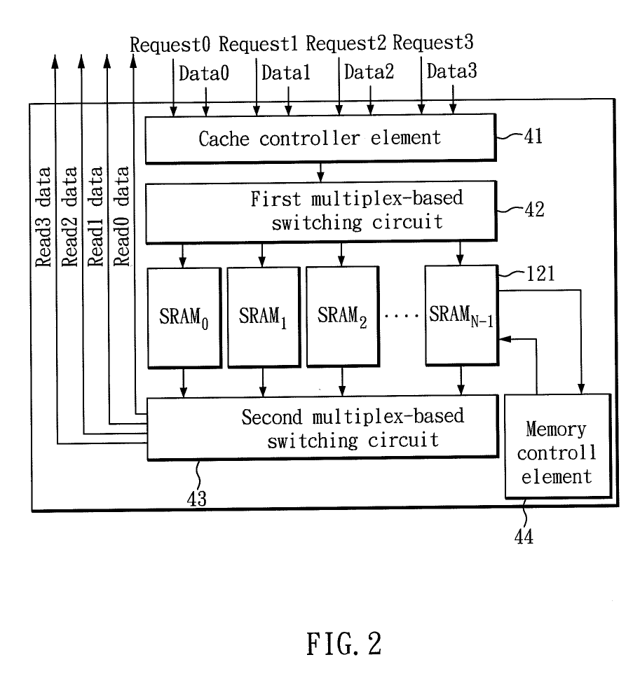

As for the cache memory element 12 of this embodiment, please refer to FIG. 2, which schematically illustrates the cache memory element of the present invention. The cache memory element of the present invention further includes: a cache controller element 41, a first multiplex-based circuit element 42, a second multiplex-based circuit element 43 and a memory control element 44. The cache controller element 41 is coupled with the plurality of processor elements 11 to receive the requests sent by the plurality of processor elements 11. The first multiplex-based circuit element 42 is coupled with the cache controller element 41 and the plurality of sub-memory elements 121. The second multiplex-based circuit element 43 is coupled with the plurality of sub-memory elements 121. Further, the memory control element 44 is coupled with the first multiplex-based circuit element 41.

The cache controller element 41 accepts the memory requests from the L1 cache memory 13. The requests issued by different L1 cache memory 13 can be executed simultaneously if the used memory resources have no conflict. The cache controller element 41 checks the selected bank tables to determine whether the data is in the cache or not. According to the check result, the corresponding data and addresses are forwarded to the sub-memory elements 121 or the memory control element 44 by the first multiplex-based circuit element 42. For read requests, the read data is forwarded to the second multiplex-based circuit element 43 and sent back to an L1 cache memory 13.

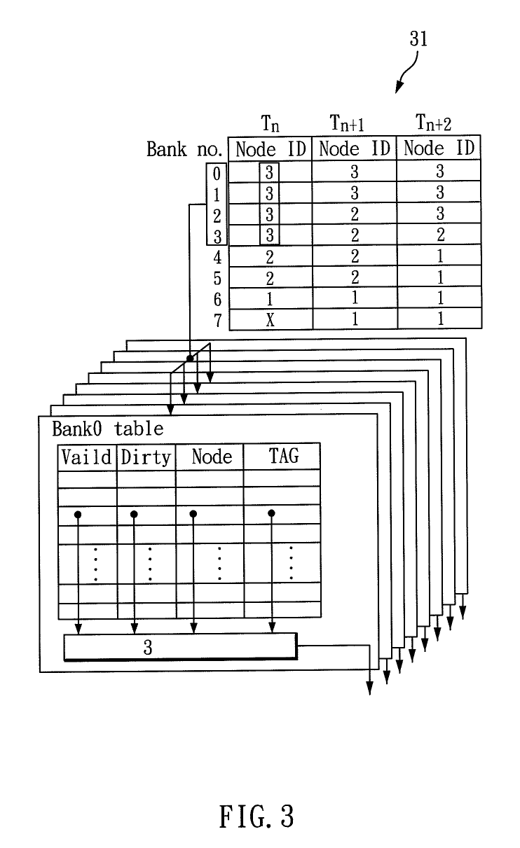

For the embodiment with four processor elements and eight sub-memory elements, in order to dynamically allocate the memory resources for different processor elements at runtime, the bank assignment table is applied to record the memory resource usage information. The bank assignment table of the preferred embodiment is able to record the memory resource usage information of three time intervals. FIG. 3 is a schematic view illustrating the bank table checking method when a request is served.

The three time intervals for recording the memory resource usage information is labeled as Tₙ, Tₙ₊₁, and Tₙ₊₂. Each processor element has its own node ID and each sub-memory has its own bank table respectively, and each bank table is numbered from 0 to 7. According to the corresponding processor element node ID, the system searches the bank assignment table 31 and returns the assigned bank numbers. These bank numbers indicate which bank tables need to be checked for the request. As shown in FIG. 3, four banks (banks, banks, bank₂, and bank₃) are applied for node 3 in the first time interval Tₙ. When a request from node 3 is served, banks, bank₁, bank₂ and bank₃ tables will be selected for hit checking. By this configuration, node 3 can own a 4-way associativity L2 cache memory resource for processing.

The bank tables record the using status and some of the logic status of each bank, such as whether the bank is valid or not, whether the bank is dirty or not, which node the bank is assigned to, and the tag of the bank.

The processor elements 11 may have different memory access behavior in different time interval at runtime. The bank assignment table 31 can record the configuration in different time interval. The bank assignment table 31 is updated by one of the processor elements 11, which can profile the memory requirements of the system. With time intervals changes, the bank assignment for each processor element 11 will be reorganized. The organization may be different from previous configurations, as in the first time interval Tₙ shown in FIG. 3, four banks are allocated to node 3, but only two banks are allocated to node 3 in the second time interval Tₙ₊₁, which implies that the loading of node 3 has decreased so that the memory requirement is not as much as with the first time interval Tₙ, and hence bank₂ and bank₃ are re-allocated to node 2 for the increasing loading of node 2 from the first time interval Tₙ to the second time interval Tₙ₊₁. Further referring to the third time interval Tₙ₊₁, the banks allocated to node 3 changes to three, which infers that the loading of node 3 has increased so that the memory requirement for node 3 is greater than that in the second time interval Tₙ₊₁.

In addition, the cross “X” labeled in the first time interval Tₙ means that bank₇ is an extra bank and is under an idle situation, and merely seven banks are sufficient for usage in the first time interval Tₙ. Under such situation, the power supplied to bank₇ will be turned off since bank₇ is not allocated to any of the processor elements for any data reading and writing, and thus the electric power consumption is saved.

What should be noticed is that, bank₂ and bank₃ are allocated to node 3 while in the first time interval Tₙ, node 3 may store data in bank₂ and bank₃. When time progresses to the second time interval Tₙ₊₁, data missing occurs since bank₂ and bank₃ with data stored therein by node 3 are no longer allocated to node 3. Therefore, node 3 will check the memory allocation configuration of the previous time interval recorded in the bank assignment table, and node 3 goes back to check bank₂ and bank₃ according to the bank assignment table so as to avoid data missing. Furthermore, the above description can be summarized as follow: while one of the plurality of processor elements finds out one of the plurality of the sub-memory elements being allocated to the one of the plurality of processor elements in the first time interval, but not being allocated to the one of the plurality of processor elements in the second time interval, through the comparison between the two records respectively corresponding to the first time interval and the second time interval, the one of the plurality of processor elements checks the one of the plurality of the sub-memory elements to determine whether data is still stored in the one of the plurality of the sub-memory elements.

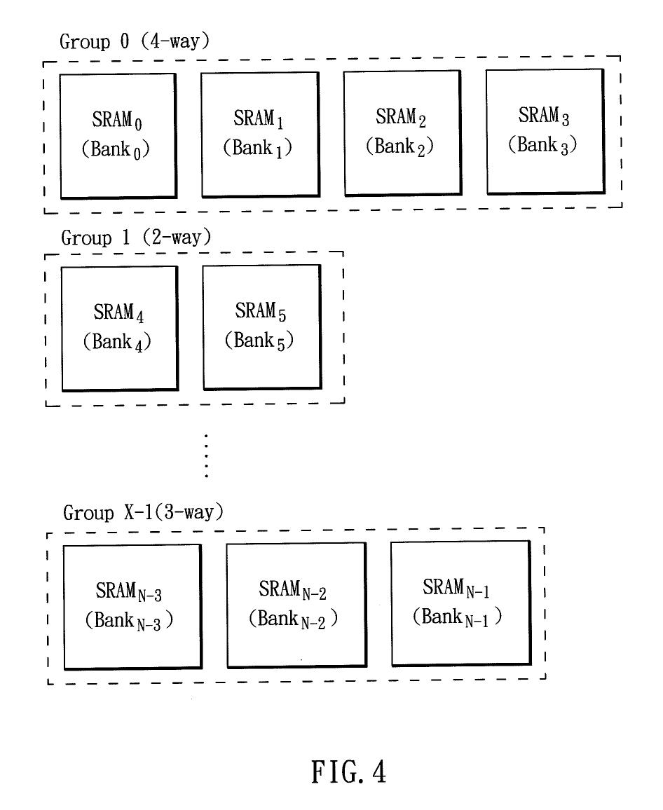

Further, in the present invention, associativity-based partitioning scheme is applied for the cache partition. Each sub-memory element represents a way and forms a bank for the cache organization. Please refer to FIG. 4, which is a schematically view illustrating a general memory allocation. As shown if FIG. 4, it is assumed that there are N sub-memory elements and X processor elements in an SoC system (where N, X are each integer greater than 1), which stands for having an N-way associativity capacity in cache memory. For different processor elements, the sub-memory elements can be grouped into several groups for processor elements. As shown in FIG. 4, N sub-memory elements are labeled as SRAM₀ to SRAM_{N-1}, and SRAM₀ to SRAM₃ are grouped together to form a 4-way associativity and the group is labeled as Group 0. All the sub-memory elements are grouped into X−1 groups to be allocated to X processor elements. Furthermore, each sub-memory element forms a bank and is labeled as bank₀ to bank_{N-1}.

The method for allocating cache memory provided by the present invention is employed to allocate memory resource adaptively to different processor element assigned for different task while the SoC system is under operation, to increase the efficiency of the entire system and further to decrease the power consumption by turning off the power of the processor element which has no task for processing during a specific runtime. The method for allocating cache memory of the present invention is applied in SoC system, wherein the cache memory element includes a plurality of sub-memory elements; to be more specific, the cache memory element is divided into a plurality of sub-memory elements.

That is, one of the plurality of processor elements is assigned to execute the method, which comprises the following steps: reading the bank assignment table; and allocating the plurality of sub-memory elements to the plurality of processor elements, in accordance with the bank assignment table, for executing the operation processes assigned to the plurality of processor elements.

The plurality of sub-memory elements are a plurality of static random access memory (SRAM) units. Further, the bank assignment table includes 3 records, each corresponding to the allocation of the plurality of sub-memory elements in 3 time intervals respectively. In addition, each sub-memory element represents a way and forms a bank for the cache organization, and each sub-memory element has its own bank table.

In addition, while one of the plurality of processor elements finds out that one of the plurality of the sub-memory elements is allocated to the one of the plurality of processor elements in the first time interval, but is not allocated to the one of the plurality of processor elements in the second time interval, through the comparison between the two records respectively corresponding to the first time interval and the second time interval, the one of the plurality of processor elements checks the one of the plurality of the sub-memory elements to determine whether the data is still stored in the one of the plurality of the sub-memory elements.

The function in the previous paragraph forms a mechanism for avoiding data missing. That is, by taking the first time interval and the second interval as consideration, if data missing occurs, the data may remain in the other sub-memory elements. The bank tables of the sub-memory elements that are assigned in the previous time interval will be checked again.

Also, the bank assignment table includes a time interval column and a plurality of allocation columns, and the number of the plurality of allocation columns equals to the number of the plurality of sub-memory elements.

Although the present invention has been explained in relation to its preferred embodiment, it is to be understood that many other possible modifications and variations can be made without departing from the scope of the invention as hereinafter claimed.

What is claimed is:

1. A method for allocating cache memory, applied in a system on chip and accompanied with a bank assignment table, the system on chip including a plurality of processor elements and a cache memory element, the cache memory element having a plurality of sub-memory elements, one of the plurality of processor elements executing the method, the method comprising the steps of:
reading the bank assignment table; and
allocating the plurality of sub-memory elements to the plurality of processor elements, in accordance with the bank assignment table, for executing the operation processes assigned to the plurality of processor elements.

2. The method for allocating cache memory as claimed in claim 1, wherein the plurality of sub-memory elements is a plurality of static random access memory elements.

3. The method for allocating cache memory as claimed in claim 1, wherein the bank assignment table includes N records, each corresponding to the allocation of the plurality of sub-memory elements in N time intervals respectively, where N is an integer of 3 to 6.

4. The method for allocating cache memory as claimed in claim 3, wherein the bank assignment table includes three records, each of the three records corresponding to the allocation of the plurality of sub-memory elements in a first time interval, a second time interval, and a third time interval, respectively.

5. The method for allocating cache memory as claimed in claim 4, wherein while one of the plurality of processor elements finds out one of the plurality of the sub-memory elements being allocated to the one of the plurality of processor elements in the first time interval, but not being allocated to the one of the plurality of processor elements in the second time interval, through a comparison between the two records respectively corresponding to the first time interval and the second time interval, the one of the plurality of processor elements checks the one of the plurality of the sub-memory elements to determine whether data is still stored in the one of the plurality of the sub-memory elements.

6. The method for allocating cache memory as claimed in claim 1, wherein the bank assignment table includes a time interval column and a plurality of allocation columns, and the number of the plurality of allocation columns equals to the number of the plurality of sub-memory elements.

7. A system on chip for allocating cache memory, comprising:
a plurality of processor elements; and
a cache memory element including a plurality of sub-memory elements, and coupled with the plurality of processor elements,
wherein a bank assignment table is built in one of the plurality of processor elements, and the processor element with the built-in bank assignment table allocates the plurality of sub-memory elements to the plurality of processor elements, in accordance with the bank assignment table, for executing an operation processes assigned to the plurality of processor elements.

8. The system on chip for allocating cache memory as claimed in claim 7, wherein each of the plurality of processor elements includes an L1 cache memory.

9. The system on chip for allocating cache memory as claimed in claim 7, wherein the plurality of sub-memory elements is a plurality of static random access memory elements.

10. The system on chip for allocating cache memory as claimed in claim 7, wherein the bank assignment table includes N records, each corresponding to the allocation of the plurality of sub-memory elements in N time intervals respectively, where N is an integer of 3 to 6.

11. The system on chip for allocating cache memory as claimed in claim 10, wherein the bank assignment table includes three records, each of the three records corresponding to the allocation of the plurality of sub-memory elements in a first time interval, a second time interval, and a third time interval, respectively.

12. The system on chip for allocating cache memory as claimed in claim 11, wherein while one of the plurality of processor elements finds out one of the plurality of the sub-memory elements being allocated to the one of the plurality of processor elements in the first time interval, but not being allocated to the one of the plurality of processor elements in the second time interval, through a comparison between the two records respectively corresponding to the first time interval and the second time interval, the one of the plurality of processor elements checks the one of the plurality of the sub-memory elements to determine whether data is still stored in the one of the plurality of the sub-memory elements.

13. The system on chip for allocating cache memory as claimed in claim 7, wherein the bank assignment table includes a time interval column and a plurality of allocation columns, and the number of the plurality of allocation columns equals to the number of the plurality of sub-memory elements.

14. The system on chip for allocating cache memory as claimed in claim 7, wherein the cache memory element further includes:
a cache controller element coupled with the plurality of processor elements to receive requests sent by the plurality of processor elements;
a first multiplex-based circuit element coupled with the cache controller element and the plurality of sub-memory elements;
a second multiplex-based circuit element coupled with the plurality of sub-memory elements; and
a memory control element coupled with the first multiplex-based circuit element.

15. The system on chip for allocating cache memory as claimed in claim 14, wherein the memory control element is a dynamic random access memory controller.

16. The system on chip for allocating cache memory as claimed in claim 7, wherein the number of the plurality of processor elements is between 4 and 8.

17. The system on chip for allocating cache memory as claimed in claim 7, wherein the number of the sub-memory elements is between 8 and 32.
